(19) United States
(12) Patent Application Publication
(10) Pub. No.: US 2023/0070708 A1
(43) Pub. Date: Mar. 9, 2023

(54) MACHINE FOR CLEANING VEHICLE RUBBER FLOOR MATS

(71) Applicants: Jon P. Kolquist, Royal Palm Beach, FL (US); Derek Kolquist, Royal Palm Beach, FL (US)

(72) Inventors: Jon P. Kolquist, Royal Palm Beach, FL (US); Derek Kolquist, Royal Palm Beach, FL (US)

(21) Appl. No.: 17/897,868

(22) Filed: Aug. 29, 2022

Related U.S. Application Data
(60) Provisional application No. 63/240,518, filed on Sep. 3, 2021.

(51) Int. Cl. B60S 3/00

(52) U.S. Cl. CPC B60S 3/008

(57) ABSTRACT

A washing machine for washing vehicle floor mats that are made of rubber includes a housing with an interior washing chamber having an arrangement of rotating water nozzles that direct a pressurized spray of water onto the top side of the rubber floor mat that is held in opposing relation to the water nozzles. An electric motor operates a water pump to direct pressurized waterflow to the water nozzles. At the end of a washing cycle, the electric motor and pump are disabled and an air blower is activated to direct a flow of air onto the rubber floor mat during a drying cycle. A drain on the floor of the washing chamber directs the dirty water out of the housing of the machine which may be directed to a collection reservoir or the surrounding environment.

This non-provisional patent application is based on provisional patent application Ser. No. 63/240,518 filed on Sep. 3, 2021.

### BACKGROUND OF THE INVENTION

### Field of the Invention

The present invention is directed to a machine for cleaning floor mats found in vehicles and, more particularly, to a machine for washing vehicle floor mats that are made entirely of rubber.

### Description of the Related Art

Most vehicles use floor mats to protect the carpeted floors from wear and exposure to dirt, water, and other materials that may stain the carpet in the vehicle. These protective floor mats may be made of a combination of a rubber bottom and a carpet material on the top side that may match the color of the carpet in the vehicle. Carpeted or fabric top vehicle floor mats are usually cleaned by a vacuum process, either with a handheld vacuum nozzle, or a machine that allows the vehicle floor mat to be pulled through an arrangement of rollers and brushes while simultaneously vacuuming the carpeted or fabric top surface of the floor mat. Carpeted or fabric vehicle floor mats are usually flat and therefor are able to be fed through this type of machine having rollers and a rotating brush. In the event the carpeted or fabric floor mats become stained, they can be washed with a brush and carpet cleaner or other detergent.

Vehicle floor mats that are formed entirely of a rubber material are becoming increasingly popular. This is because they are generally easier to maintain clean, simply by washing with water with no need for cleaning chemicals and detergents. Many all-rubber floor mats are custom formed for particular vehicle models and have raised edges so that they contain water and other liquids, such as from rain or snow coming off of vehicle occupants' shoes. The configuration of these custom molded all-rubber floor mats makes it difficult, if not impossible, to feed them through a machine having rollers and brushes. Moreover, there is really no need to brush all-rubber floor mats, as they are better cleaned by spraying water directly on the exposed surfaces to remove dirt, sand and other debris. The process for cleaning rubber floor mats with a high-pressure hose, and possibly a handheld brush, is not always practical, particularly at a self-service carwash. Much like the automated vehicle floor mat vacuum machines used for floor mats having a carpeted or fabric surface, there is a need for an automated machine for washing all-rubber vehicle floor mats.

### SUMMARY OF THE INVENTION

The present invention provides a machine that is structured for automated washing of vehicle floor mats that are made entirely of rubber. The floor mat washing machine includes an outer housing, with a front door that may hinge open at the bottom or along one side. The inside of the door is adapted to hold a rubber floor mat in place, possibly with the use of clips or other mechanisms, such as an open wire frame basket, so that the top surface of the floor mat faces away from the inside door surface and towards the interior washing chamber of the machine. Within the interior washing chamber, the machine includes at least one, and preferably multiple water nozzles that are connected to a water pump driven by an electric motor. The water pump is connected to a water supply, such as a municipal water system, a water holding tank or other water containing reservoir. During operation, the water pump delivers a pressurized flow of water from the water supply to the water nozzles. The water nozzles are specifically arranged, angled and structured to spin about a central axis as a result of the thrust of the pressurized water exiting the nozzles. Thus, during operation, the arrangement of multiple water nozzles spins while directing a pressurized spray from the multiple nozzles onto the exposed top surface of the rubber floor mat that is secured to the inside surface of the closed door of the machine. The interior washing chamber of the machine further includes an air blower that automatically turns on after completion of the washing process, at which time the pressurized waterflow from the pump to the water nozzles stops. The air blower directs air onto the all-rubber vehicle floor mat to promote drying. The dirty water in the interior washing chamber exits through a bottom drain which may be directed out to the surrounding environment, or into a containment tank or other device for disposal.

### BRIEF DESCRIPTION OF THE DRAWINGS

For a fuller understanding of the nature of the present invention, reference should be had to the following detailed description taken in connection with the accompanying drawings in which:

FIG. 1 is a front perspective view of the rubber floor mat washing machine according to one embodiment of the present invention shown with a front door open and an all-rubber floor mat secured to the inside panel of the front door;

FIG. 2 is a front perspective view of the rubber floor mat washing machine of FIG. 1 with the door closed and shown in phantom lines along with the rubber floor mat that is attached to the inside of the closed door, and illustrating the various components within a washing chamber of the machine; and

FIG. 3 is a front perspective view of the rubber floor mat washing machine in accordance with another embodiment of the invention that has an open wire frame basket on the inside of the door for holding the rubber floor mat.

Like reference numerals refer to like parts throughout the several views of the drawings.

### DETAILED DESCRIPTION OF THE PREFERRED EMBODIMENTS

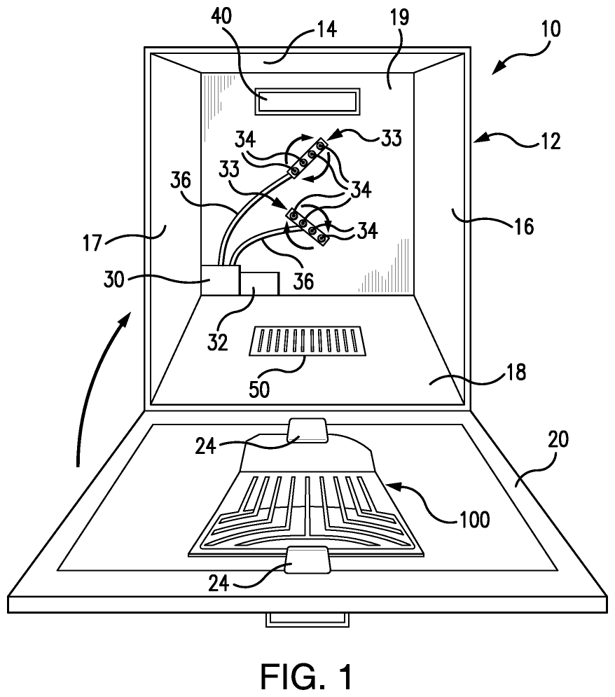

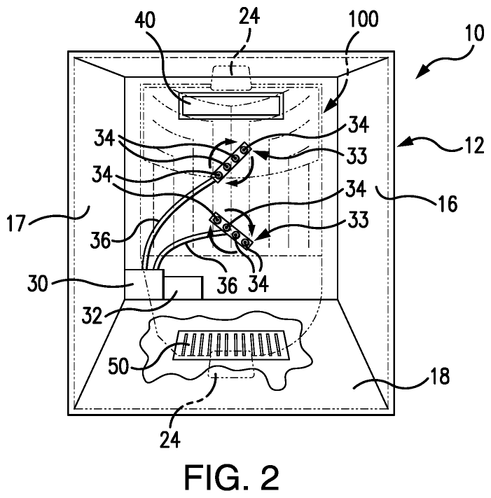

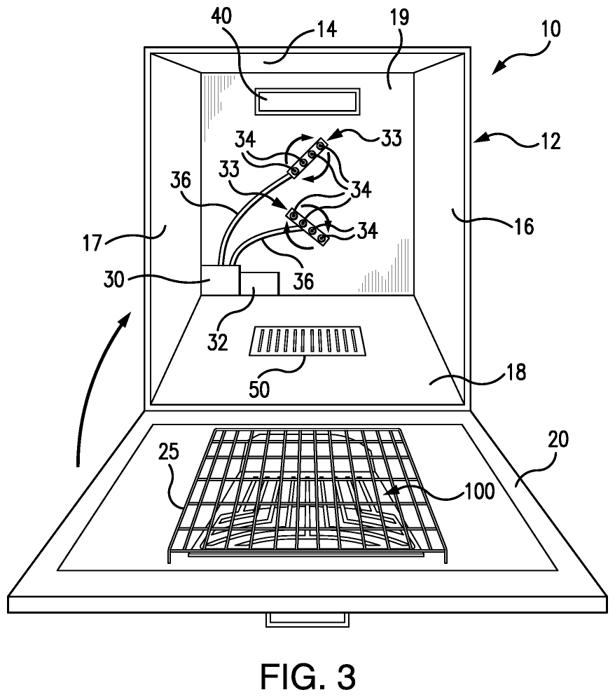

Referring to FIGS. 1-3, the rubber floor mat washing machine is shown and is generally indicated as 10. The rubber floor mat washing machine 10 includes a housing 12 having a top 14, opposite side walls 16, 17, a base or floor 18 and a back wall 19. The housing 12 further includes a door 20 that hinges open and closed, as illustrated in FIGS. 1 and 2. The door 20 may be hinged along the bottom, or along one side so that it swings open to allow access to the interior washing chamber, as well as to allow for placement of a rubber floor mat 100 to be secured within the washing chamber. In the embodiment shown in FIGS. 1 and 2, the rubber floor mat 100 is secured to the inside panel of the front door 20 with clips 24 or other suitable mechanisms. As seen in FIG. 1, the rubber floor mat 100 is secured by the clips 24 so that the top side of the rubber floor mat 100 faces away from the door and towards the interior washing chamber, in opposing relation to water nozzles 34 and an air blower 40 on the back wall 19. In the embodiment shown in FIG. 3, an open wire frame basket 25 is secured to the inside of the door 20 for holding the rubber floor mat 100 with the top side of the floor mat 100 facing the washing chamber in opposing relation to the water nozzles 34 and the air blower. Aside from the particular mechanisms for holding the rubber floor mat 100 in position on the front door, as described above, all other aspects of the washing machine are the same in FIGS. 1-3.

Once the rubber floor mat 100 is secured in place, the door 20 can be closed so that the rubber floor mat 100 is held vertically, with the top surface of the rubber floor mat 100 in opposing relation to the water nozzles 34 and air blower 40. In operation, a water pump 30 driven by an electric motor 32 directs a pressurized flow of water from a water supply through hoses 36 that connect to the water nozzles 34. The water pump is connected to a water supply, such as a municipal water system, a water holding tank or other water containing reservoir. As seen in FIGS. 1 and 2, the water nozzles are provided in an arrangement of at least two, and preferably four or more nozzles 34 on a rotating nozzle manifold 33. Each water nozzle manifold 33 is connected to an associated hose or conduit 36 to receive the pressurized waterflow from the water pump 30. The pressurized waterflow exits each of the nozzles 34 on the manifold 33, causing the arrangement of nozzles 34 to spin, as illustrated in FIGS. 1 and 2. More specifically, the nozzles 34 are angled in a manner that causes the entire water nozzle manifold to spin about a central axis in response to the thrust of force of water exiting the nozzles during operation of the water pump. The thrust of water exiting the nozzles 34 is directed onto the top side of the rubber floor mat 100 to wash dirt and other debris off of the rubber floor mat 100, and otherwise clean the floor mat 100. The dirty water from washing the rubber floor mat 100 falls to the bottom floor 18 and exits through drain 50. The dirty water that exits through the drain may be directed to the surrounding environment or to a collection reservoir for disposal. In operation, the electric motor 32 and water pump 30 are operated for a timed sequence sufficient to thoroughly wash the rubber floor mat 100. At the end of the timed sequence, the electric motor 32 is stopped, and pressurized waterflow from the pump 30 to the water nozzles 34 is stopped. Next, an air blower 40 in the washing chamber is activated to direct a forced flow of air onto the top side of the rubber floor mat 100 through a timed sequence of a drying process. At the end of the timed sequence of operation of the air blower, the air blower shuts off and the door 20 can be opened to retrieve the clean and dry rubber floor mat 100.

Since many modifications, variations and changes in detail can be made to the described embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A machine for cleaning rubber floor mats comprising:
a housing having an interior enclosed washing chamber;
a plurality of water nozzles in the washing chamber;
a water pump in fluid flow connection with the plurality of water nozzles and structured and disposed for directing a pressurized flow of water to the plurality of water nozzles, and the plurality of water nozzles being structured and disposed for releasing the pressurized flow of water in a pressurized sprayed array of water within the interior washing chamber;
an air blower structured and disposed for releasing a forced flow of air into the interior washing chamber; and
at least one holding mechanism within the interior washing chamber for holding at least one rubber floor mat with a top side of the at least one rubber floor mat maintained in direct opposing relation to the plurality of water nozzles and the air blower so that the pressurized sprayed array of water and the forced flow of air are directed onto the top side of the at least one rubber floor mat for cleaning and drying thereof.

2. The machine as recited in claim 1 wherein the housing includes at least one door operable between an open position and a closed position to enclose the interior washing chamber.

3. The machine as recited in claim 2 wherein the at least one door includes an inner side facing the interior washing chamber when the at least one door is in the closed position; and
the at least one holding mechanism fitted to the inner facing side of the at least one door for holding the at least one rubber floor mat with the top side of the at least one rubber floor mat maintained in direct opposing relation to the plurality of water nozzles and the air blower.

4. The machine as recited in claim 3 wherein the housing further includes a top wall, opposite side walls, a floor and a back wall, and the back wall arranged in opposing relation to the at least one door.

5. The machine as recited in claim 4 wherein the plurality of water nozzles and the air blower are positioned on an inner facing side of the back wall within the interior washing chamber, and in direct opposing relation to the inner side of the at least one door.

6. The machine as recited in claim 5 further comprising:
at least one manifold supported on the inner facing side of the back wall and the at least one manifold containing at least a portion of the plurality of water nozzles.

7. The machine as recited in claim 6 wherein the at least one manifold is rotatably supported on the inner facing side of the back wall, and the at least one manifold being structured and disposed to rotate upon receipt of the pressurized flow of water from the water pump and to direct the pressurized flow of water to the at least a portion of the plurality of water nozzles contained on the manifold.
